(19) United States
(12) Patent Application Publication
(10) Pub. No.: US 2012/0119587 A1
(43) Pub. Date: May 17, 2012

(54) WIRELESS POWER TRANSFER DEVICE

(75) Inventors: Sang Hoon CHEON, Daejeon (KR); Yong Hae KIM, Daejeon (KR); Myung Lae LEE, Daejeon (KR); Seung Youl KANG, Daejeon (KR); Taehyoung ZYUNG, Daejeon (KR)

(73) Assignee: ELECTRONICS AND TELECOMMUNICATIONS RESEARCH INSTITUTE, Daejeon (KR)

(21) Appl. No.: 13/204,331

(22) Filed: Aug. 5, 2011

(30) Foreign Application Priority Data
Nov. 12, 2010 (KR) 10-2010-0112701

(51) Int. Cl. H01F 38/14

(52) U.S. Cl. 307/104

(57) ABSTRACT

Provided is a wireless power transfer device. The wireless power transfer device includes an power generator, and two or more non-radiative electromagnetic wave generators. The power generator generates AC type of power. The non-radiative electromagnetic wave generators receive the power, and generate non-radiative electromagnetic waves through resonance. The non-radiative electromagnetic wave generators are disposed to form a wireless power transfer-enabled transfer area.

### CROSS-REFERENCE TO RELATED APPLICATIONS

This U.S. non-provisional patent application claims priority under 35 U.S.C. §119 of Korean Patent Application No. 10-2010-0112701, filed on Nov. 12, 2010, the entire contents of which are hereby incorporated by reference.

### BACKGROUND OF THE INVENTION

The present invention disclosed herein relates to a wireless power transfer device.

Electronic products including modern appliances are rapidly being miniaturized and made portable. Since a large portion of information and signal transmission is wirelessly processed, line connections to equipment are becoming obsolete. For appliances, efforts are underway to wirelessly transfer even electrical power. Typically, the electromagnetic induction scheme is the most commonly used method for transferring power wirelessly. Specifically, wireless power transfer using electromagnetic induction is currently applied to power toothbrushes, etc., but involve the limitations that transfer efficiency is reduced too much when distance is even slightly increased and that unnecessary and dangerous heat can be produced by eddy currents.

Wireless power transfer based on magnetic resonance, a non-radiative wireless power transfer technology recently being studied, can obtain higher transfer efficiency at greater distances (of even several meters) than the typical electromagnetic induction method. This technology is based on evanescent wave coupling by which electromagnetic waves move from one medium to another through near electromagnetic fields when the two media resonate at the same frequency. Thus, power is transferred only when the resonance frequencies between two media are the same, and power that is not transferred is re-absorbed by the electromagnetic fields. The electromagnetic waves are therefore harmless to surrounding machines or humans, unlike other electromagnetic waves.

A transmitter and a receiver in a wireless power transfer system based on magnetic resonance each includes one resonator for resonating at a transfer frequency, and can transfer power at high transfer efficiency when resonance frequencies of the two resonators are exactly the same. For implementation of an actual system, since the resonance frequencies of the two resonators gradually become disparate, each of the transmitter and the receiver includes a device for adjusting resonance frequency to compensate for the difference. A variable capacitor may be used as the frequency adjusting device, whereupon the breakdown voltage of the capacitor must be very high because very high voltages across a coil are generated. Also, impedance matching of the transmitter and the receiver at the transfer frequency is essential, for which a distance between a transmit coil and a source coil and a distance between a receive coil and a load coil should be suitably adjusted.

While power in the magnetic resonance scheme can be wirelessly transferred farther than in the electromagnetic induction scheme, transfer efficiency is still reduced with distance. The situation becomes more complex when a receiving electronic device is not fixed. The optimal impedance matching point cannot be set because the position of the electronic device is not fixed, and thus, the drop in transfer efficiency inevitably increases further from the transmit coil. The present invention provides a method for increasing the efficiency of wireless power transfer based on magnetic resonance and for performing optimal wireless power transfer when the position of a receiving device is variable.

### SUMMARY OF THE INVENTION

The present invention provides a wireless power transfer device which enhances efficiency of wireless power transfer based on magnetic resonance, and forms a wireless transfer-enabled transfer area.

Embodiments of the inventive concept provide a wireless power transfer device including: an power generator generating power; and two or more non-radiative electromagnetic wave generators receiving the power, and generating non-radiative electromagnetic waves through resonance, wherein the non-radiative electromagnetic wave generators are disposed to form a wireless power transfer-enabled transfer area.

In some embodiments, each of the non-radiative electromagnetic wave generators may include: a transmit resonance coil receiving the power, and generating the non-radiative electromagnetic waves through resonance; and a drive coil delivering the power to the transmit resonance coil which receives an Alternating Current (AC) signal corresponding to the generated power to resonate.

In other embodiments, resonance frequencies of the respective transmit resonance coils of the non-radiative electromagnetic wave generators may be the same.

In still other embodiments, the wireless power transfer device may further include a resonance frequency regulator regulating a resonance frequency of the transmit resonance coil of the each non-radiative electromagnetic wave generator.

In even other embodiments, the resonance frequency regulator may include a variable capacitor serially connected to the transmit resonance coil.

In yet other embodiments, the non-radiative electromagnetic wave generators may be disposed at vertices of a polygon, respectively.

In further embodiments, the non-radiative electromagnetic wave generators may be disposed at a circumference of a circle, respectively.

In still further embodiments, the non-radiative electromagnetic wave generators may be disposed symmetrically about the center of the transfer area.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a block diagram illustrating a wireless power transfer device according to an embodiment of the present invention;

FIG. 2 is a diagram illustrating a first embodiment of the wireless power transmitter of FIG. 1;

FIG. 3 is a diagram to illustrate a second embodiment of the wireless power transmitter of FIG. 1;

FIG. 4 is a diagram illustrating a wireless power transmitter of a wireless power transfer device according to another embodiment of the invention;

FIG. 5 is a diagram illustrating a first embodiment of a transfer area formed by non-radiative electromagnetic wave generators of a wireless power transfer device according to the present invention;

FIG. 6 is a diagram illustrating a second embodiment of a transfer area formed by non-radiative electromagnetic wave generators of a wireless power transfer device according to the present invention;

FIG. 7 is a diagram illustrating a third embodiment of a transfer area formed by non-radiative electromagnetic wave generators of a wireless power transfer device according to the present invention;

FIG. 8 is a diagram showing a gain of a wireless power transfer device according to an embodiment of the invention;

FIG. 9 is a diagram showing transfer efficiency of a wireless power transfer device according to an embodiment of the invention; and

FIG. 10 is a diagram illustrating a communication system applying a wireless power transfer device according to embodiments of the invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

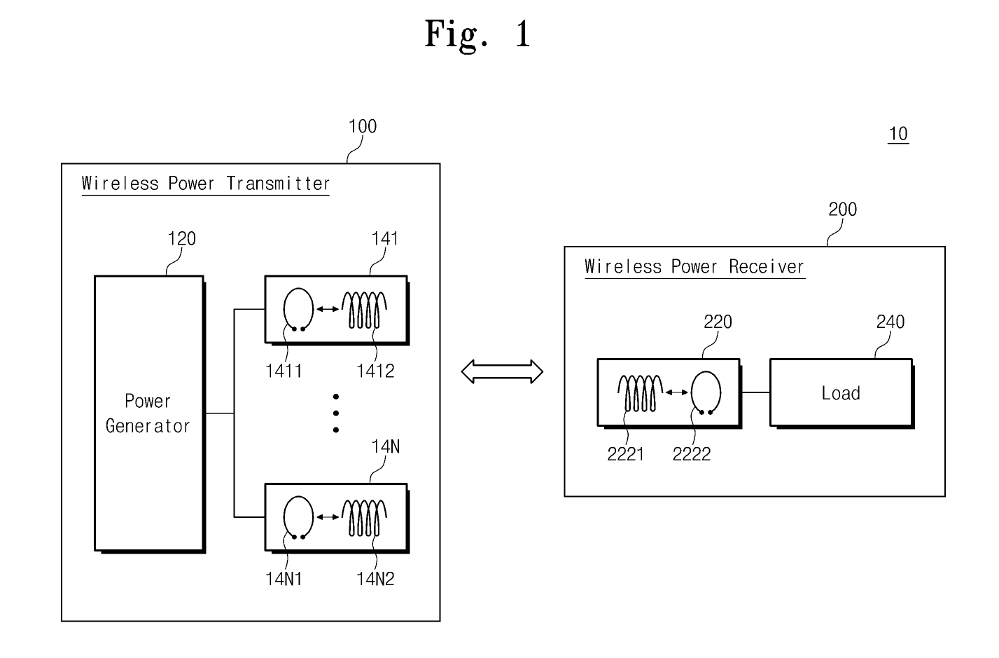

FIG. 1 is a block diagram illustrating a wireless power transfer device 10 according to an embodiment of the present invention. Referring to FIG. 1, the wireless power transfer device 10 includes a wireless power transmitter 100 and a wireless power receiver 200.

The wireless power transfer device 10 according to an embodiment of the present invention may transfer power with a non-radiative wireless power transfer technology. Such a non-radiative wireless power transfer technology may allow power to be transferred from a longer distance than a typical electromagnetic induction scheme and at higher efficiency than an electromagnetic radiation scheme. Herein, the non-radiative wireless power transfer technology is based on evanescent wave coupling in which electromagnetic waves move from one medium to another medium through near electromagnetic fields when two media resonate at the same frequency. In this case, power is transferred when the resonance frequencies of the two media are the same, and unused power is not radiated to the air but re-absorbed by the electromagnetic fields. Therefore, electromagnetic waves which are used in the non-radiative wireless power transfer technology are harmless to peripheral machines or human body unlike other electromagnetic waves.

The wireless power transmitter 100 includes an power generator 120 and a plurality of non-radiative electromagnetic wave generators 141 to 14N. Herein, N is an integer equal to or more than 2.

The power generator 120 is implemented as an inverter or a power amplifier, and receives a commercial power source to generate AC type of power.

Each of non-radiative electromagnetic wave generators 141 to 14N receives the AC signal from the power generator 120, and thus generates non-radiative electromagnetic waves through resonance.

Each of non-radiative electromagnetic wave generators 141 to 14N includes a corresponding drive coil and transmit resonance coil. Hereinafter, for convenience, the drive coil 1411 and the transmit resonance coil 1412 of the first non-radiative electromagnetic wave generator 141 will be described in detail.

The drive coil 1411 receives the AC signal generated by the power generator 120, and thus delivers the AC signal to the transmit resonance coil 1412. Usually, the number of turns is 1, but several turns may be used for impedance matching. A metal, which has good conductivity and a thickness greater than the skin depth at a use frequency, is used for reducing resistive loss. The drive coil 1411 is disposed at an appropriate optimal distance from the transmit resonance coil 1412 for impedance matching.

The transmit resonance coil 1412 resonates with the power received from the drive coil 1411 to generate non-radiative electromagnetic waves. The transmit resonance coil 1412 has the natural resonance frequency. In an embodiment of the present invention, the resonance frequencies of the respective transmit resonance coils 1412 to 14N2 of the non-radiative electromagnetic wave generators 141 to 14N may be the same.

The transmit resonance coil 1412 also uses a metal which has good conductivity and a thickness greater than the skin depth at the use frequency so as to reduce resistive loss. The transmit resonance coil 1412, as illustrated in FIG. 1, may be implemented in a helical structure or a spiral structure.

In the wireless power transfer device 10 according to an embodiment of the present invention, when an area for wireless power transfer does not have a symmetrical structure, a matching circuit is disposed at the front stage of the drive coil 1411, and by controlling the matching circuit, a transfer efficiency distribution of an area in which wireless power transfer is performed may be controlled.

A wireless power receiver 200 is a device that receives the non-radiative electromagnetic waves generated by the wireless power transmitter 100. The wireless power receiver 200 may be one of various kinds of electronic devices such as mobile phones and portable computers. Such electronic devices may be directly driven with power received through non-radiative electromagnetic waves, and electronic devices including a battery may be charged with the power.

The wireless power receiver 200 includes a non-radiative electromagnetic wave receiver 220 and a load 240. The non-radiative electromagnetic wave receiver 220 includes a receive resonance coil 2221 and a load coil 2222. The receive resonance coil 2221 receives non-radiative electromagnetic waves generated from the transmit resonance coil 1412 when resonating.

In an embodiment of the present invention, the receive resonance coil 2221 may have a helical structure. In another embodiment of the present invention, the receive resonance coil 2221 may have a spiral structure. The load coil 2222 delivers power received from the receive resonance coil 2221 to the load 240. The load coil 2222 is disposed at an appropriate optimal distance from the receive resonance coil 2221 for impedance matching.

The load 240 converts power received from the non-radiative electromagnetic wave receiver 220 to DC power and uses the DC power.

The wireless power transfer device 10 according to an embodiment of the present invention includes a plurality of non-radiative electromagnetic wave generators 141 to 14N, thereby increasing wireless power transfer efficiency.

Also, the non-radiative electromagnetic wave generators 141 to 14N may be disposed, and thus the wireless power transfer device 10 according to an embodiment of the present invention may form a wireless power transfer-enabled transfer area.

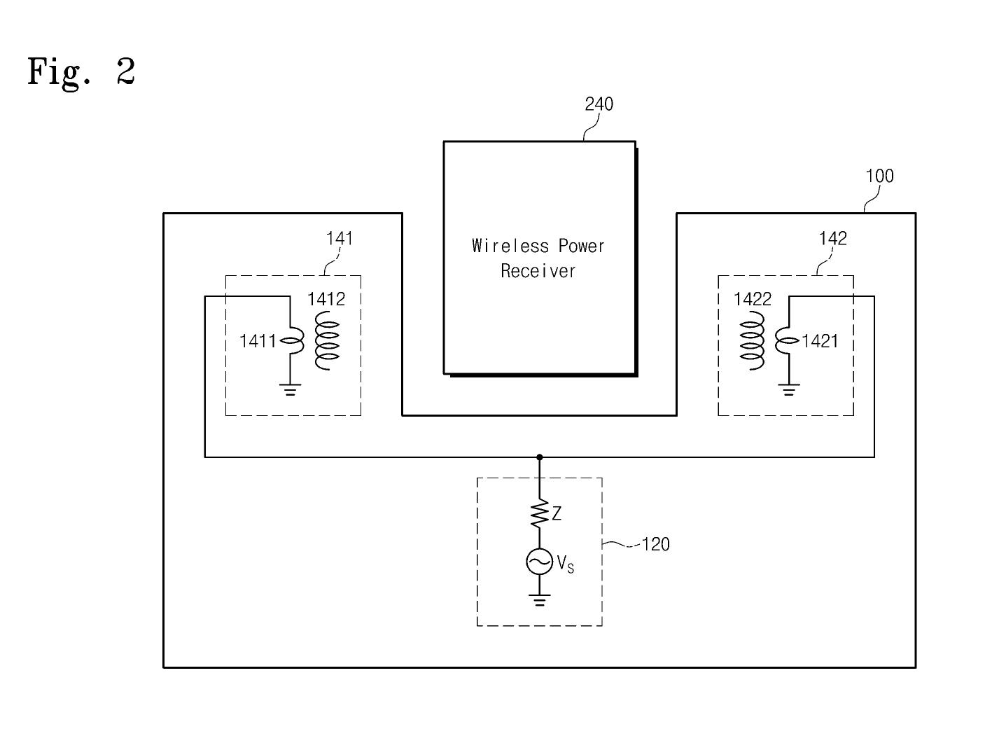

FIG. 2 is a diagram illustrating a first embodiment of the wireless power transmitter 100 of FIG. 1. Referring to FIG. 2, the wireless power transmitter 100 includes an power generator 120, and first and second non-radiative electromagnetic wave generators 141 and 142.

Each of the first and second non-radiative electromagnetic wave generators 141 and 142 is connected to the power generator 120. The first non-radiative electromagnetic wave generator 141 includes a first drive coil 1411 and a first transmit resonance coil 1412. The second non-radiative electromagnetic wave generator 142 includes a second drive coil 1421 and a second transmit resonance coil 1422. Herein, resonance frequencies of the first and second transmit resonance coils 1412 and 1422 may be the same.

A wireless power transfer-enabled transfer area is formed between the first and second non-radiative electromagnetic wave generators 141 and 142. The wireless power receiver 200 may receive power through non-radiative electromagnetic waves in the transfer area.

The wireless power transmitter 100 of FIG. 2 includes the two non-radiative electromagnetic wave generators 141 and 142. However, the wireless power transmitter 100 according to the invention should not be limited thereto. The wireless power transmitter 100 according to the invention may include at least two non-radiative electromagnetic wave generators.

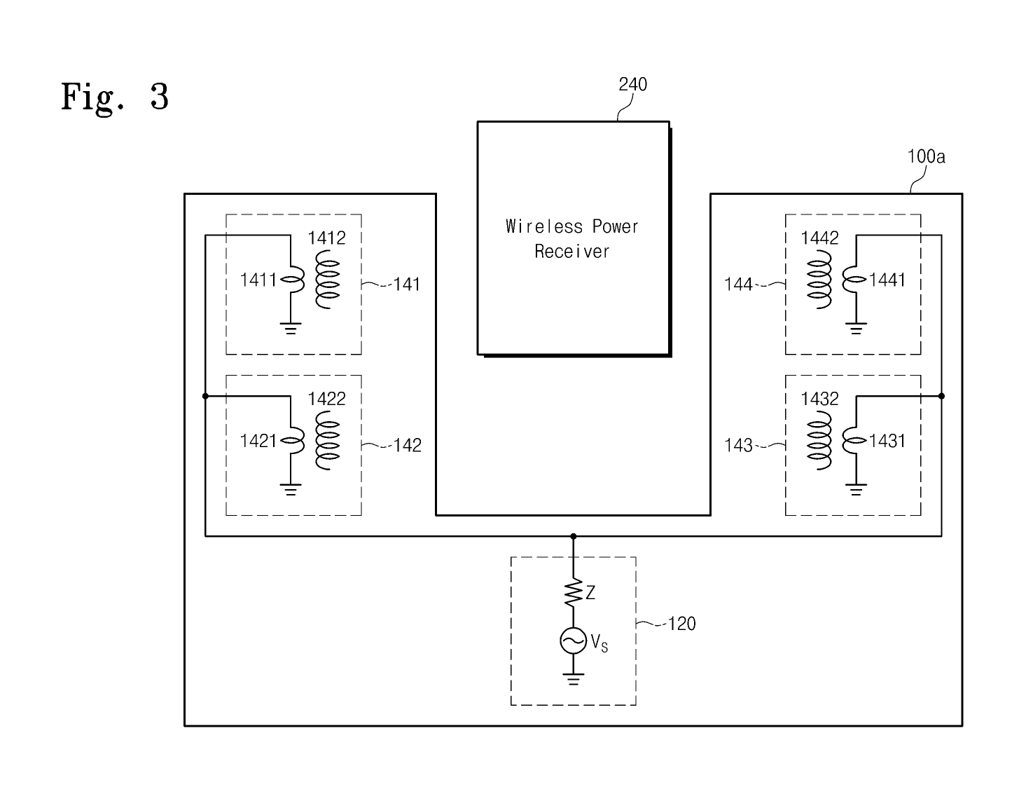

FIG. 3 is a diagram illustrating a second embodiment of the wireless power transmitter 100a of FIG. 1. Referring to FIG. 3, the wireless power transmitter 100a includes an power generator 120, and first to fourth non-radiative electromagnetic wave generators 141 to 144. Herein, resonance frequencies of the first to fourth non-radiative electromagnetic wave generators 141 to 144 may be the same.

A wireless power transfer-enabled transfer area is formed among the first to fourth non-radiative electromagnetic wave generators 141 to 144. The wireless power receiver 200 may receive power through non-radiative electromagnetic waves in the transfer area.

The wireless power transmitter according to an embodiment of the present invention may further include at least one resonance frequency regulator for regulating the resonance frequencies of the transmit resonance coils.

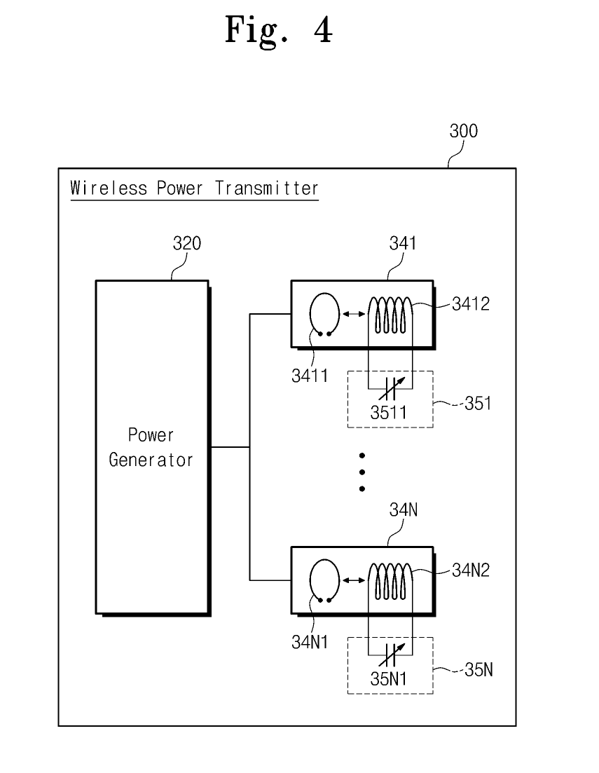

FIG. 4 is a diagram illustrating a wireless power transmitter 300 according to another embodiment of the present invention. Referring to FIG. 4, the wireless power transmitter 300 includes an power generator 320, a plurality of non-radiative electromagnetic wave generators 341 to 34N, and a plurality of resonance frequency regulators 351 to 35N.

The power generator 320 is implemented identically to the power generator 120 of FIG. 1. The non-radiative electromagnetic wave generators 341 to 34N are implemented identically to the non-radiative electromagnetic wave generators 141 to 14N of FIG. 1.

The resonance frequency regulators 351 to 35N are connected to the transmit resonance coils 3412 to 34N2 of the non-radiative electromagnetic wave generators 341 to 34N, respectively. In an embodiment of the present invention, each of the resonance frequency regulators 351 to 35N may be implemented with a variable capacitor. Herein, the variable capacitor may be serially connected to a drive coil so as to form a resonance loop.

The wireless power transmitter 300 according to an embodiment of the present invention includes the resonance frequency regulators 351 to 35N, finely controlling a resonance frequency. Therefore, the wireless power transmitter 300 according to another embodiment of the present invention can maximize wireless power transfer efficiency.

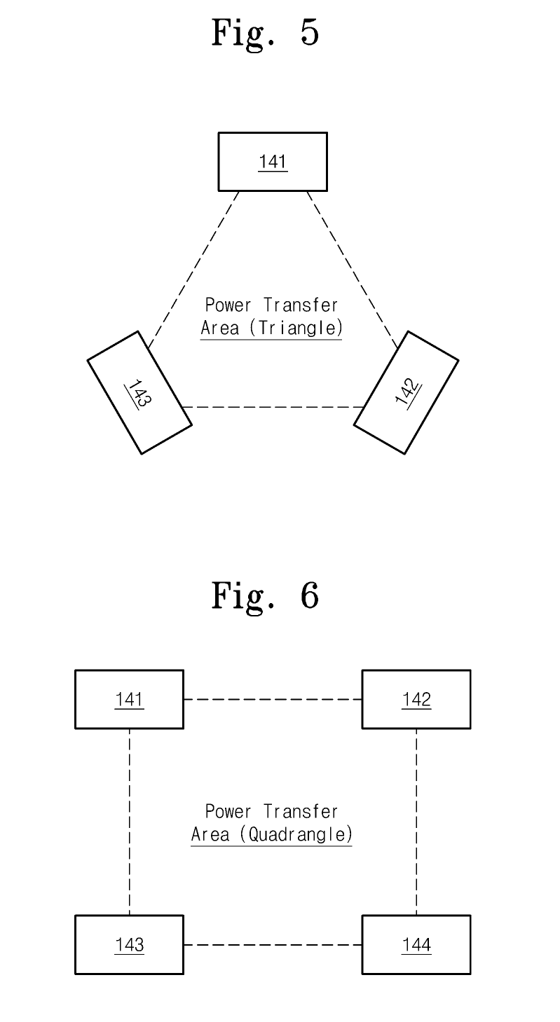

The non-radiative electromagnetic wave generators 141 to 14N are disposed, and thus the wireless power transfer device 10 according to an embodiment of the present invention forms a wireless power transfer-enabled transfer area. Embodiments of the transfer areas are illustrated in FIG. 5 to FIG. 7. In an embodiment of the present invention, the plurality of non-radiative electromagnetic wave generators 141 to 14N may be disposed symmetrically about the center of the transfer area.

FIG. 5 is a diagram illustrating a first embodiment of a transfer area formed by the non-radiative electromagnetic wave generators 141 to 143 of the wireless power transmitter 100 according to the present invention. Referring to FIG. 5, the three non-radiative electromagnetic wave generators 141 to 143 are disposed at vertices of a triangle, and thus a triangular transfer area is formed. Herein, the triangle may be an equilateral triangle.

FIG. 6 is a diagram illustrating a second embodiment of a transfer area formed by the non-radiative electromagnetic wave generators 141 to 144 of the wireless power transmitter 100 according to the present invention. Referring to FIG. 6, the four non-radiative electromagnetic wave generators 141 to 144 are disposed at vertices of a quadrangle, and thus a quadrangular transfer area is formed. Herein, the quadrangle may be a square.

As illustrated in FIG. 5 and FIG. 6, in the wireless power transmitter 100 according to an embodiment of the present invention, non-radiative electromagnetic wave generators 141 to 14N are disposed at vertices of a polygon, and thus a polygonal transfer area may be formed.

In the wireless power transmitter 100 according to an embodiment of the present invention, the non-radiative electromagnetic wave generators 141 to 14N are disposed at a circumference of a circle, and thus a circular transfer area may be formed.

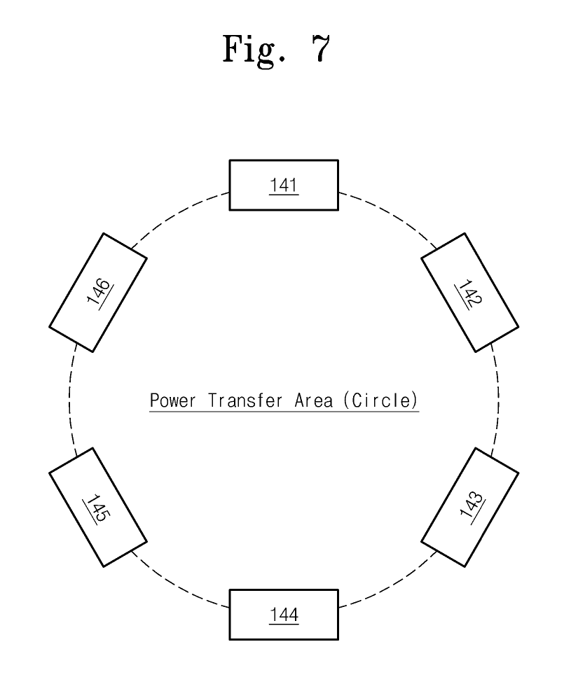

FIG. 7 is a diagram illustrating a third embodiment of a transfer area formed by the non-radiative electromagnetic wave generators 141 to 146 of the wireless power transmitter 100 according to the present invention. Referring to FIG. 7, the six non-radiative electromagnetic wave generators 141 to 146 are disposed at a circumference of a circle, and thus a circular transfer area is formed.

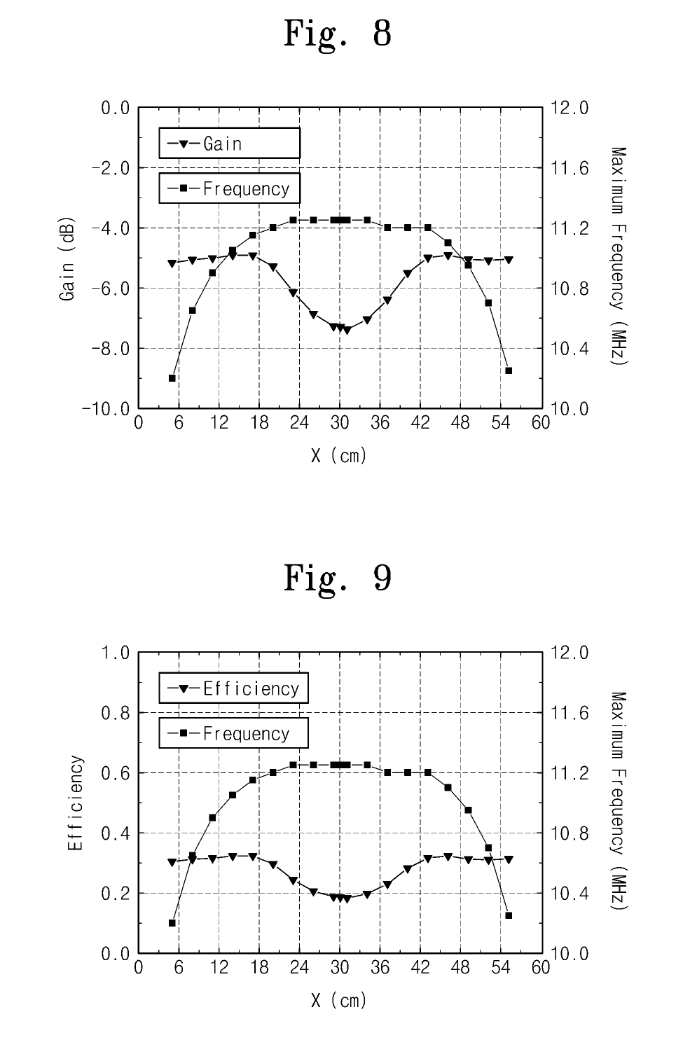

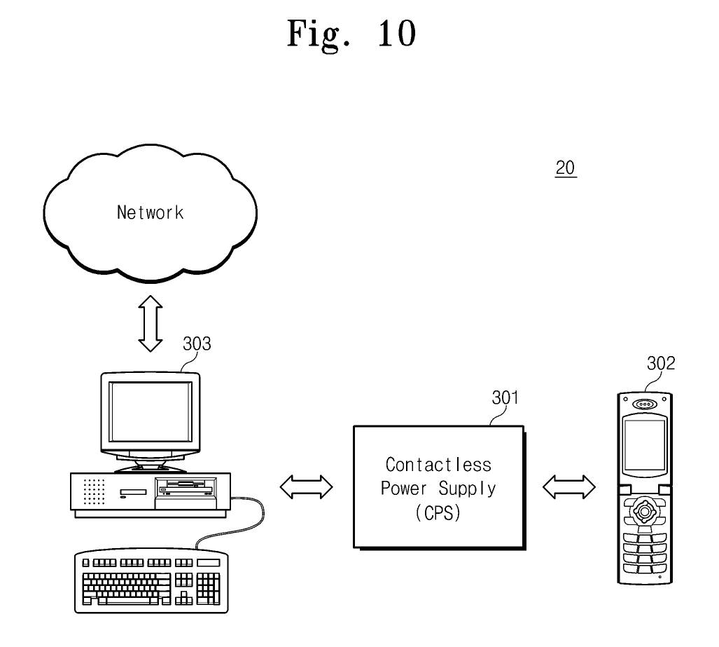

FIG. 8 is a diagram showing a gain of the wireless power transfer device 10 according to an embodiment of the present invention. First, the wireless power transfer device 10 includes the two non-radiative electromagnetic wave generators 141 and 142, which are separated from each other by 60 cm. Referring to FIG. 8, when a distance X from the first non-radiative electromagnetic wave generator 141 is 30 cm, a transfer gain and a resonance frequency are the highest possible. FIG. 9 shows transfer efficiency at this point.

FIG. 10 is a diagram exemplarily illustrating a communication system applying a wireless power transfer system according to an embodiment of the present invention. Referring to FIG. 10, a communication system 20 includes a contactless power supply device 301, a terminal device 302, and a workstation 303 connected to a network.

The contactless power supply device 301 is connected to the workstation 303 and is implemented to have the same operation and configuration as those of the wireless power transmitter 100 of FIG. 1. The contactless power supply device 301 may establish a communication link between the terminal device 302 and the workstation 303. Herein, the communication link is used to transmit/receive data to/from the terminal device 320. The terminal device 302 is implemented to have the same operation and configuration as those of the wireless power receiver 200 of FIG. 1.

As described above, in the wireless power transfer device including the wireless power transmitter according to the embodiments of the present invention, the non-radiative electromagnetic wave generators are disposed, and thus a wireless power transfer-enabled transfer area is formed, thereby maximizing transfer efficiency.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A wireless power transfer device comprising:
an power generator generating AC type of power; and
two or more non-radiative electromagnetic wave generators receiving the power, and generating non-radiative electromagnetic waves through resonance,
wherein the non-radiative electromagnetic wave generators are disposed to form a wireless power transfer-enabled transfer area.

2. The wireless power transfer device of claim 1, wherein each of the non-radiative electromagnetic wave generators comprises:
a transmit resonance coil receiving the power, and generating the non-radiative electromagnetic waves through resonance; and
a drive coil delivering the power to the transmit resonance coil which receives an Alternating Current (AC) signal corresponding to the generated power to resonate.

3. The wireless power transfer device of claim 2, wherein resonance frequencies of the respective transmit resonance coils of the non-radiative electromagnetic wave generators are the same.

4. The wireless power transfer device of claim 2, further comprising a resonance frequency regulator regulating a resonance frequency of the transmit resonance coil of the each non-radiative electromagnetic wave generator.

5. The wireless power transfer device of claim 4, wherein the resonance frequency regulator comprises a variable capacitor serially connected to the transmit resonance coil.

6. The wireless power transfer device of claim 1, wherein the non-radiative electromagnetic wave generators are disposed at vertices of a polygon, respectively.

7. The wireless power transfer device of claim 1, wherein the non-radiative electromagnetic wave generators are disposed at a circumference of a circle, respectively.

8. The wireless power transfer device of claim 1, wherein the non-radiative electromagnetic wave generators are disposed symmetrically about the center of the transfer area.
